(19) United States
(12) Patent Application Publication
(10) Pub. No.: US 2011/0094204 A1
(43) Pub. Date: Apr. 28, 2011

(54) COUPLING SYSTEM CONNECTING AN INTERNAL STRUCTURE AND AN EXTERNAL STUCTURE OF A JET ENGINE NACELLE

(75) Inventors: Florent Bouillon, Anglesqueville (FR); Pat Dunleavy, Palaiseau (FR)

(73) Assignee: AIRCELLE, Gonfreville L'Orcher (FR)

(21) Appl. No.: 12/673,259

(22) PCT Filed: Jun. 20, 2008
(86) PCT No.: PCT/FR08/00864

§ 371 Date: Feb. 12, 2010

(30) Foreign Application Priority Data
Aug. 20, 2007 (FR) 0705890

(51) Int. Cl. F02K 3/04

(52) U.S. Cl. 60/226.1

(57) ABSTRACT

The present invention relates to a turbofan jet engine nacelle intended to be attached to a structure of an aircraft by an engine strut and comprising a forward air inlet section, a mid-section intended to surround a jet engine fan, and an aft section having an internal structure intended to serve as a casing for an aft portion of the jet engine and, together with an external structure (5), defining a flow duct (7) for a secondary stream, the internal structure having substantially radial extensions (61) passing through the duct and via which it is connected to an inner panel (51) of the external structure by means of at least one corresponding stiffener (110) having a right-angled general shape, characterized in that the stiffener is also fastened in an external panel (52) of the external structure.

### TECHNICAL FIELD

The present invention relates to a jet engine nacelle intended to be attached to a structure of an aircraft by a connection strut.

### BACKGROUND

An aircraft is propelled by a number of jet engines each housed in a nacelle.

A nacelle generally has a tubular structure comprising an air inlet upstream of the jet engine, a mid-section intended to surround a fan of the jet engine, and a downstream section optionally incorporating thrust reversal means and intended to surround the combustion chamber of the jet engine, and is generally terminated by an exhaust nozzle whose outlet is situated downstream of the jet engine.

Modern nacelles are intended to accommodate a turbofan jet engine designed to generate, on the one hand, a hot air stream (also known as the primary stream) from the combustion chamber of the jet engine, and, on the other hand, a cold air stream (secondary stream) from the fan and flowing outside the turbofan through an annular passage, also known as a duct, formed between an internal structure defining a cowling of the jet engine and an internal wall of the nacelle. The two air streams are ejected from the jet engine via the rear end of the nacelle.

In order to be able to carry out maintenance operations inside the nacelle in an easy manner, the rear section generally takes the form of two half-portions mounted on the strut by means of hinges so that they can be opened radially about a longitudinal axis situated in the vicinity of the strut. Such a structure is referred to as “C-Duct”. The half-portions are connected to one another at their lower part by means of locks.

In order to simplify the opening of said rear section, the external structure and the internal structure are mechanically connected and secured within the same half-portion. Thus, opening the half-portions allows direct access to the jet engine and there is no need to open the external structure and then the internal structure.

The connection between the internal structure and the external structure is produced by means of radial extensions of the internal structure extending in radial directions through the duct as far as an inner wall of the external structure. These extensions are generally situated at six-o'clock and at twelve-o'clock, that is to say respectively in the vicinity of the locking line between the two half-portions and the hinge lines in the region of the strut.

The external structure and the internal structure are secured by bolting a stiffener having a right-angled shape and fastened both to an extension of the internal structure and to an end of the lower panel of the external structure.

A smooth fairing is fastened between the same walls on the stream flow duct side in order to provide good inner aerodynamic continuity.

In flight, the elements of the nacelle are subjected to various stresses and forces. The internal structure and the inner panel of the external structure are particularly subjected to high pressure forces which induce tensile forces and rotation moments exerted on the stiffener.

The main consequences are a tendency of the connection beams to rotate and also a radial displacement of the knife-edge coupling which retains the rear section with the mid-section.

It also follows that the stiffener must be securely fastened in the internal structure and the inner panel of the external structure. Since the latter are generally formed by acoustic panels, it is necessary to introduce interruptions in these panels, the bolting not being able to pass through an acoustic surface. This leads to a reduction in the effective acoustic surface area.

Another consequence is also the overdimensioning of the hinges and of the locks which retain the external structure in flight.

Therefore, there is a need for a more effective fastening and retaining system which makes it possible to better withstand the forces exerted on the external and internal structures.

### BRIEF SUMMARY

The present invention is thus particularly aimed at providing a nacelle having an improved fastening between the internal structure and the external structure of the rear section and to this end relates to a turbofan jet engine nacelle intended to be attached to a structure of an aircraft by a connection strut and comprising an air inlet front section, a mid-section intended to surround a jet engine fan, and a rear section having an internal structure intended to serve as a casing for a rear portion of the jet engine and defining, together with an external structure, a flow duct for a secondary stream, the internal structure having substantially radial extensions passing through the duct and via which it is connected to an inner panel of the external structure by means of at least one corresponding stiffener having a right-angled general shape, characterized in that the stiffener is also fastened in an external panel of the external structure.

Thus, the connection of the stiffener with not only the internal panel of the external structure but also the external panel of said structure allows a better balance of the forces so as to prevent the beams from rotating. Specifically, the fastening on the external panel of the external structure makes it possible for the deformation forces exerted on said structure also to be transmitted to the stiffener and generates rotation moments which, at least in part, oppose the rotation moments tending to entrain the beams.

This makes possible, among other advantages, a monolithic junction in place of a sandwich junction which would require interruptions in the acoustic panels; but is also makes possible a reduction in the size of the movement of the knife-edge coupling and to solve some of the problems of disengaging said coupling.

Preferably, at least one stiffener is situated in the region of a means for fastening the nacelle to a beam of the strut.

In a preferable manner, the rear section is broken down into at least two substantially hemicylindrical half-portions on either side of a substantially vertical plane of the nacelle.

Advantageously, the means for attaching the rear section to the strut are demountable.

Again advantageously, the means for attaching the rear section to the strut are hinges.

In a preferable manner, the nacelle comprises means for locking the half-portions along a lower longitudinal line of the nacelle.

Advantageously, it comprises stiffeners for each half-portion which are situated substantially in the region of at least one locking means.

Preferably, the internal structure is produced from an acoustic panel.

Again preferably, the internal panel of the external structure is produced from an acoustic panel.

### BRIEF DESCRIPTION OF THE DRAWINGS

Other features and advantages of the present invention will become apparent in light of the description which follows and from an examination of the appended figures, in which:

FIG. 1 is a front perspective schematic representation of a rear section of a jet engine nacelle;

FIG. 2 is a schematic representation of a half-portion of the rear section shown in FIG. 1;

FIG. 3 is an enlarged partial view of a half-portion of the rear section comprising a connection between the internal structure and external structure according to the prior art taken in the region of a lower lock;

FIG. 4 is a schematic representation of a connection between the internal structure and external structure according to the invention taken in the region of a hinge or upper lock;

FIGS. 5 to 10 are representations of different embodiments of the fastening of FIG. 4 as a function of the positioning of the locks along the rear section.

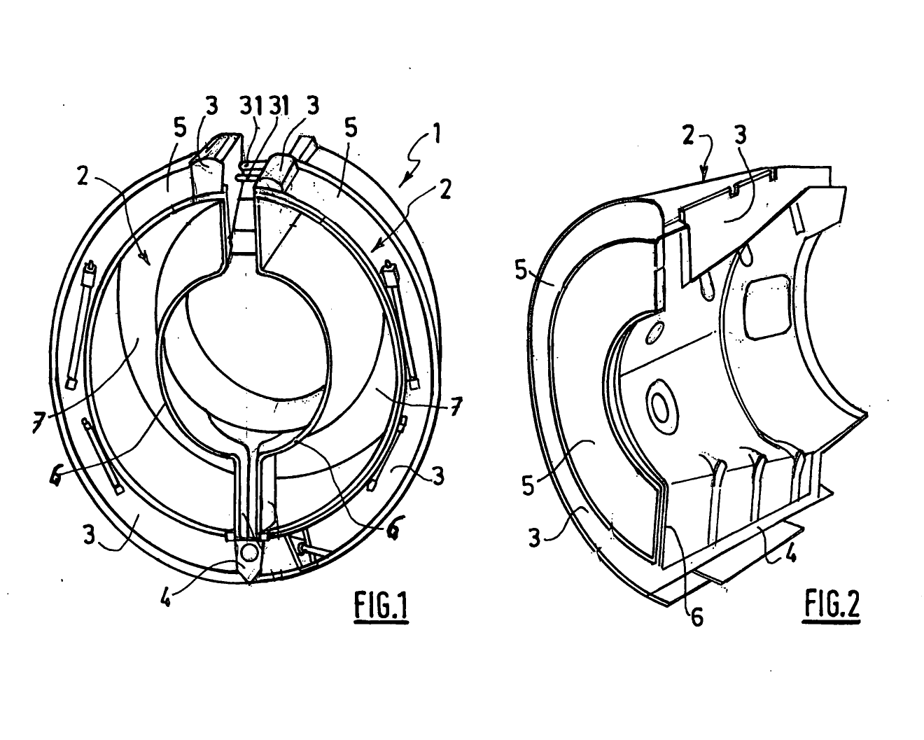

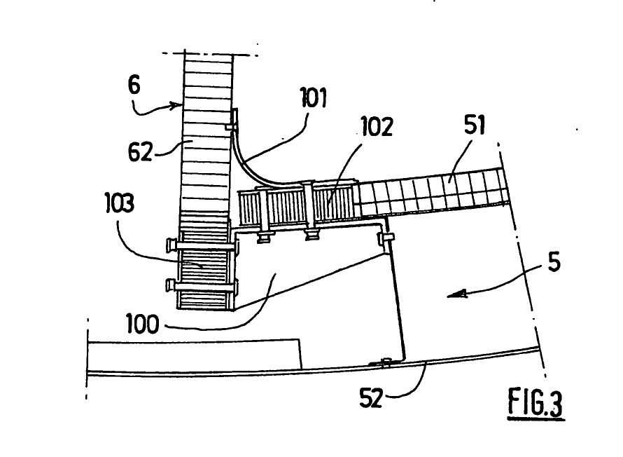

FIG. 1 shows a rear section 1 intended to equip a turbofan jet engine nacelle.

The rear section 1 is produced in the form of two substantially hemicylindrical half-portions 2 intended to be fastened around the jet engine on either side of a strut (not shown).

Each half-portion 2 comprises an upper longitudinal beam 3 and a lower longitudinal beam 4 serving together as a reinforcement for an external structure 5 intended to provide the outer aerodynamic continuity of the nacelle and an internal structure 6 intended to surround a rear portion of the jet engine. The external structure 5 and the internal structure 6 together define a flow duct 7 for the cold stream.

More precisely, the flow duct 7 is delimited by the internal structure 6, on the one hand, and by an inner wall 51 of the external structure 5. The external structure 5 also has an external wall 52 intended for its part to provide the external aerodynamic continuity.

The internal wall 51 and the external wall 52 join together downstream of the rear section to form an end nozzle and together define an inner space (not referenced) generally intended to house auxiliary equipment of the nacelle.

The internal structure 6 is connected to the rest of the corresponding half-portion 2 via an upper radial extension 61 and a lower radial extension 62 extending as far as the internal wall 51 of the external structure to which it is fastened.

Each upper longitudinal beam 3 has means 31 for connection to the strut which are uniformly distributed along said beam 3. Conventionally, in the case of openable half-portions 2, the connection means will take the form of eyes which are able to form a hinge with a corresponding tenon of the strut.

Each lower longitudinal beam 4 has attachment means designed to cooperate with complementary attachment means of the corresponding lower longitudinal beam 4 of the other half-portion. These will typically be locks.

FIG. 3 schematically shows the way in which the internal structure 6 is connected to the external structure 5 according to the prior art.

The internal structure 6 is connected to the external structure 5 by means of one or more stiffeners 100 distributed along the rear section 1, each stiffener 100 substantially having a right-angled shape of which one side is fastened, by bolting for example, in the internal wall 51 of the external structure 5 and of which a second side is fastened, also by bolting, in the lower radial extension 62.

The connection is completed by a smooth fairing 101 likewise fastened both to the lower radial extension 62 and to the inner wall 52 of the external structure 5.

It should be noted, as mentioned above, that the internal structure 6, including the lower 62 and upper 61 radial extensions, and also the internal wall 51 of the external structure 5 are produced from acoustic panels. It follows that the fastening of the stiffeners 100 cannot be carried out directly in these acoustic panels, which leads to introducing material interruptions so as to provide zones 102, 103 made of a material whose structure allows such a fastening.

The same connection principle applies mutatis mutandis to the upper radial extension 61.

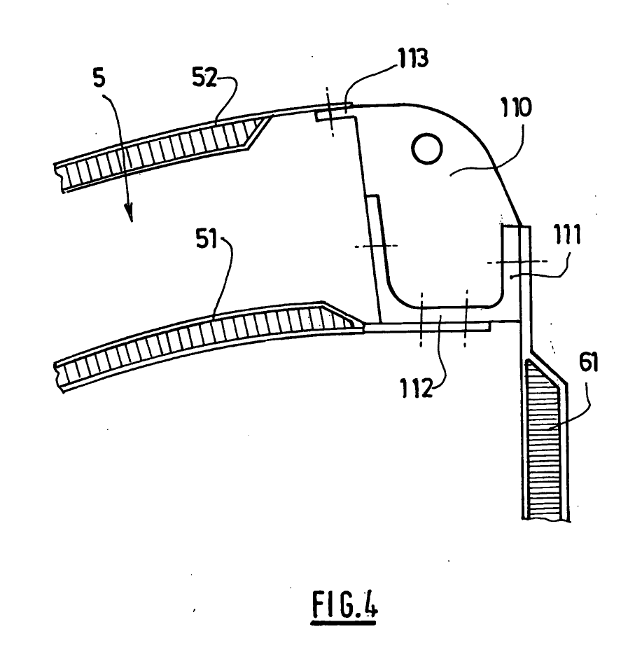

FIG. 4 is a representation of the principle of the invention.

According to the invention, the connection between the internal structure 6 and the external structure 5 is produced via stiffeners 110.

Each stiffener 110 conventionally has a first rim 111 intended to be fastened in a radial extension 61, 62 of the internal structure 6 and a second rim 112, substantially forming a right angle with the first rim 111, intended to be fastened in the internal panel 52 of the external structure 5.

The stiffener 110 differs from a stiffener 100 by the fact that it also comprises an extension or an arm 113 which can be fastened in the external wall 51 of the external structure 5.

It will be noted that, since the forces are reduced, there is no longer any need to provide an interruption in the acoustic panels so as to incorporate therein a zone made of a material capable of supporting the bolting. As shown in FIG. 4, each panel has a thin end directly receiving the stiffener 110.

Exemplary embodiments of the invention are shown in FIGS. 6 to 11 for stiffeners arranged at different points along the rear section 1.

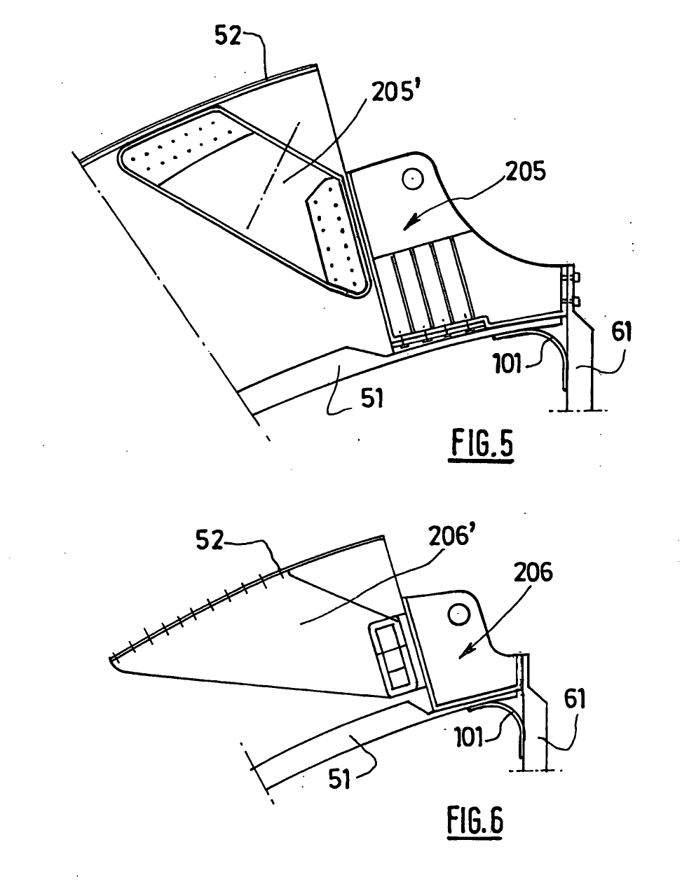

FIGS. 5 to 7 show the invention applied in the region of an upper longitudinal beam 3 whereas FIGS. 8 to 10 show the invention applied in the region of a lower longitudinal beam 4.

FIG. 5 shows a stiffener 205 intended to be situated in the region of the first hinge, that is to say the most upstream hinge on the rear section 1, a location withstanding the largest deformations and where the distance between the internal wall 512 and the external wall 52 is largest. The stiffener 205 is therefore equipped with a reinforced arm 205′ connected to the external wall 51.

FIG. 6 shows a stiffener 206 intended to be situated in the region of the second hinge, that is to say a more downstream hinge with respect to the first hinge, a location again withstanding large deformations, the distance between the internal wall 51 and the external wall 52 being smaller, however. The stiffener 206 is equipped with an arm 206′ connected to the external wall 51.

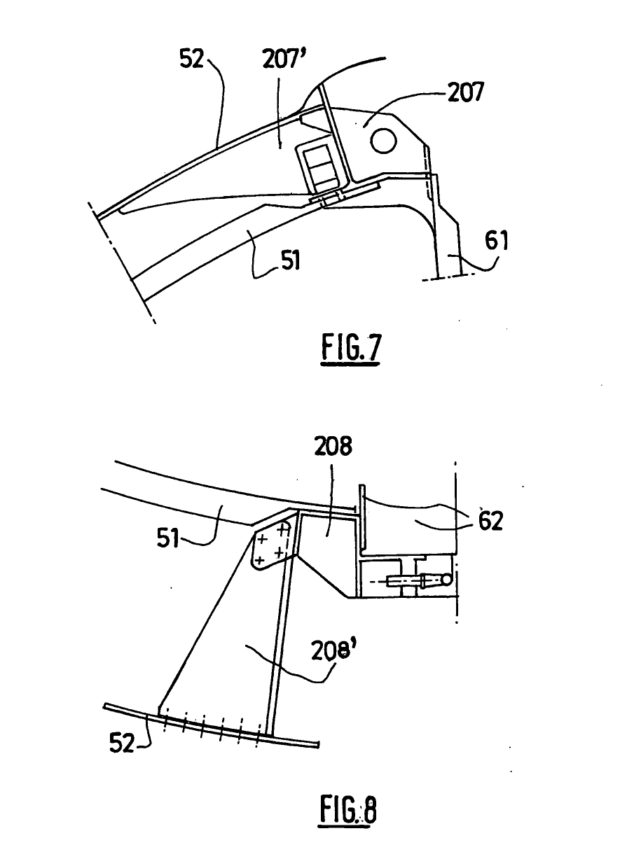

FIG. 7 shows a stiffener 207 intended to be situated in the region of the third hinge, that is to say the last-but-one hinge. The stiffener 207 is equipped with an arm 207′ connected to the external wall 51.

Of course, the length over which the arm of the stiffener is fastened in the external wall 51 is adapted as a function of the material from which said arm and the stiffener are made, and also as a function of the forces to be absorbed at the location in question.

FIG. 8 shows a stiffener 208 intended to be situated in the region of the first lower lock, that is to say the most upstream lock. The stiffener 208 is equipped with an arm 208′ connected to the external wall 51.

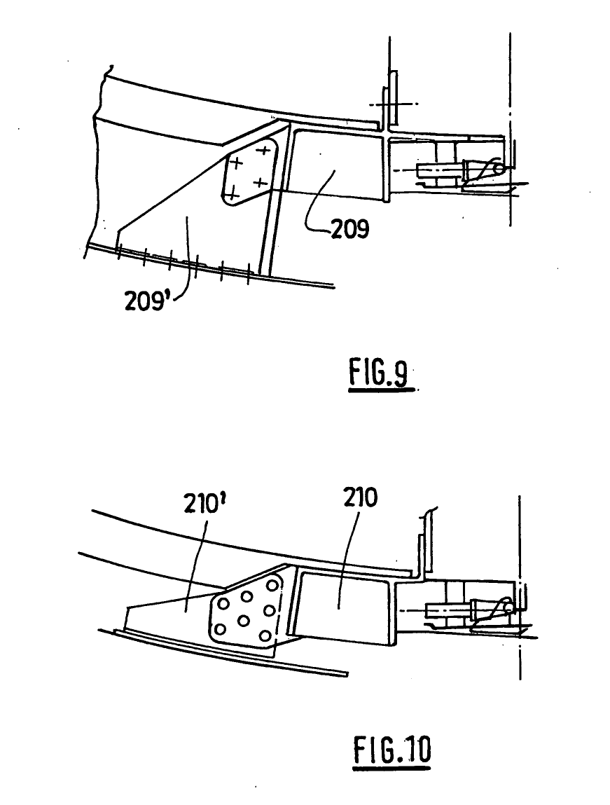

FIG. 9 shows a stiffener 209 intended to be situated in the region of the first lower lock, that is to say the most upstream lock. The stiffener 208 is equipped with an arm 208′ connected to the external wall 51.

Of course, the present invention is in no way limited to the embodiments described and represented, which are provided by way of simple illustrative examples.

1. A turbofan jet engine nacelle intended to be attached to a structure of an aircraft by a connection strut and comprising
an air inlet front section,
a mid-section intended to surround a jet engine fan, and
a rear section having an internal structure intended to serve as a casing for a rear portion of the jet engine and defining, together with an external structure, a flow duct for a secondary stream, the internal structure having substantially radial extensions passing through the duct and via which it is connected to an inner panel of the external structure by means of at least one corresponding stiffener having a right-angled general shape, wherein the stiffener is also fastened in an external panel of the external structure.

2. The nacelle as claimed in claim 1, further comprising at least one stiffener situated in a region of a means for fastening the nacelle to a beam of the strut.

3. The nacelle as claimed in claim 1, wherein the rear section is broken down into at least two substantially hemicylindrical half-portions on either side of a substantially vertical plane of the nacelle.

4. The nacelle as claimed in claim 3, wherein the means for attaching the rear section to the strut are demountable.

5. The nacelle as claimed in claim 3, wherein the means for attaching the rear section to the strut are hinges.

6. The nacelle as claimed in claim 3, further comprising means for locking the half-portions along a lower longitudinal line of the nacelle.

7. The nacelle as claimed in claim 6, further comprising stiffeners for each half-portion which are situated substantially in a region of at least one locking means.

8. The nacelle as claimed in claim 1, wherein the internal structure is produced from an acoustic panel.

9. The nacelle as claimed in claim 1, wherein the internal panel of the external structure is produced from an acoustic panel.
